(19) United States
(12) Patent Application Publication
(10) Pub. No.: US 2026/0237742 A1
(43) Pub. Date: Aug. 13, 2026

(54) ELECTROCHEMICAL APPARATUS AND ELECTRONIC APPARATUS

(71) Applicant: Ningde Amperex Technology Limited, Ningde (CN)

(72) Inventors: Zhiyi GAO, Ningde (CN); Chao TANG, Ningde (CN)

(73) Assignee: Ningde Amperex Technology Limited, Ningde (CN)

(21) Appl. No.: 19/536,295

(22) Filed: Feb. 11, 2026

(30) Foreign Application Priority Data
Feb. 12, 2025 (CN) 202510155321.7

(51) Int. Cl. H01M 10/0567; H01M 4/02; H01M 4/131; H01M 4/525; H01M 4/62; H01M 10/0525; H01M 10/0568

(52) U.S. Cl. CPC H01M 10/0567; H01M 4/131; H01M 4/525; H01M 4/623; H01M 4/625; H01M 10/0525; H01M 10/0568; H01M 2004/021; H01M 2004/028; H01M 2300/0025

(57) ABSTRACT

An electrochemical apparatus includes a positive electrode, a negative electrode, and an electrolyte. The positive electrode includes a positive electrode current collector and a positive electrode active material layer located on at least partial surface of the positive electrode current collector. The positive electrode active material layer has a compacted density of pd mg/cm³, where 2.6≤pd≤2.86. Based on a mass of the electrolyte, the electrolyte includes: ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %; where 1≤B/A≤8, and 5≤(E+D)/C≤14.

### CROSS-REFERENCE TO RELATED APPLICATION

This application claims the benefit of priority from the Chinese Patent Application No. 202510155321.7, filed on Feb. 12, 2025, the entire content of which is incorporated herein by reference.

### TECHNICAL FIELD

This application pertains to the field of energy storage technology and specifically relates to an electrochemical apparatus and an electronic apparatus.

### BACKGROUND

Various electrochemical apparatuses, dominated by secondary batteries, convert electrical energy into chemical energy through chemical reactions and release the energy when needed, and have become important pillars of modern energy storage and sustainable development. Currently, electrochemical apparatuses, with their high energy density, long cycle life, and environmental friendliness, are widely used in many fields such as electronic devices, automobiles, and aerospace.

However, with continuous development of battery technology and expansion of application fields, performance requirements for electrochemical apparatuses are also increasing. In particular, it is necessary to increase the energy density of electrochemical apparatuses to meet the endurance requirements of electronic apparatuses. Increasing the compacted density of electrode plates of electrochemical apparatuses can increase their energy density to a certain extent, but excessively high compacted density deteriorates the kinetic performance of the electrochemical apparatuses and easily causes rapid impedance growth during cycling, affecting the performance of electronic apparatuses under high-rate conditions or long-term applications. Therefore, how to improve the kinetic performance and alleviate the impedance growth issue during cycling of electrochemical apparatuses has become an urgent issue to be solved in practical applications of electrochemical apparatuses.

### SUMMARY

In view of this, this application provides an electrochemical apparatus and an electronic apparatus. Through cooperation between carboxylates and linear esters in an electrolyte, lithium ion transport inside the electrochemical apparatus can be accelerated, thereby improving the kinetic performance and alleviating the impedance growth issue.

According to a first aspect, this application provides an electrochemical apparatus including a positive electrode, a negative electrode, and an electrolyte, where the positive electrode includes a positive electrode current collector and a positive electrode active material layer located on at least partial surface of the positive electrode current collector; the positive electrode active material layer has a compacted density of pd mg/cm³, where 2.6≤pd≤2.86; and based on a mass of the electrolyte, the electrolyte includes: ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %; where 1≤B/A≤8, and 5≤(E+D)/C≤14. Ethyl propionate, propyl propionate, and diethyl carbonate are used in cooperation in this application, which can reduce viscosity of the electrolyte, accelerate lithium ion transport in a liquid phase, and improve the kinetic performance and capability of suppressing the impedance growth during cycling of the electrochemical apparatus. Adding propylene carbonate and ethylene carbonate to closely cooperate with the above electrolyte components can optimize the film-forming quality of a solid electrolyte interphase film (SEI film) at the negative electrode. Under a high positive electrode compacted density, the rate performance of the electrochemical apparatus can be further improved, and the impedance growth during cycling can be reduced.

In some more preferred embodiments, from the perspective of further improving the kinetic performance and capability of suppressing the impedance growth during cycling of the electrochemical apparatus, the electrolyte satisfies at least one of the following conditions: (1) 3≤A≤6; (2) 12≤B 20; (3) 5≤C≤8; (4) 20≤D≤30; (5) 20≤E≤40; (6) 2≤B/A≤6; or (7) 6.6≤(E+D)/C≤9.2.

In some embodiments, the electrolyte includes fluoroethylene carbonate; and based on the mass of the electrolyte, a mass percentage of fluoroethylene carbonate is P %, where 5≤P≤20. Fluoroethylene carbonate (FEC) is added to the above electrolyte system, which can reduce interfacial side reactions and improve the high-temperature intermittent cycling performance of the electrochemical apparatus. When the mass percentage of FEC is adjusted to satisfy the above range, the high-temperature intermittent cycling performance and capability of suppressing the impedance growth during cycling of the electrochemical apparatus can be further improved.

In some embodiments, the electrolyte includes 1,3,6-hexanetricarbonitrile; and based on the mass of the electrolyte, a mass percentage of the 1,3,6-hexanetricarbonitrile is Q %, where 1≤Q≤6. In this application, 1,3,6-hexanetricarbonitrile is added to the electrolyte, which can complex with transition metal sites exposed on the surface of a positive electrode material, strengthening protection on the positive electrode, and reducing the oxidative decomposition capability of the positive electrode material on the electrolyte and other irreversible reactions at a positive electrode interface, thereby alleviating the gas production during storage and cycle decay rate in high-temperature intermittent cycling tests.

In some embodiments, the electrolyte includes 1,3-propane sultone; and based on the mass of the electrolyte, a mass percentage of the 1,3-propane sultone is U %, where 1≤U 4. In this application, 1,3-propane sultone is added to the electrolyte, which can decompose and form a film on a surface of the negative electrode, reducing reductive decomposition of other components at a negative electrode interface, thereby alleviating the gas production performance during storage in high-temperature intermittent cycling tests.

In some embodiments, the electrolyte satisfies at least one of the following conditions: (1) 8≤P≤15; (2) 2≤Q≤4; or (3) 2≤U≤3.

When the electrolyte satisfies the above conditions, better cooperation among the components can be facilitated, which helps to further improve the high-temperature intermittent cycling performance and kinetic performance of the electrochemical apparatus, and alleviate the cycling impedance of the electrochemical apparatus.

In some embodiments, the electrolyte includes lithium hexafluorophosphate and a second lithium salt, the second lithium salt including lithium tetrafluoroborate or lithium difluorophosphate; and based on the mass of the electrolyte, a mass percentage of the second lithium salt is V %, where 0.1≤V≤0.8, preferably 0.2≤V≤0.4. The second lithium salt is added to the electrolyte to cooperate with lithium hexafluorophosphate, which can strengthen protection on interfaces in the positive electrode and/or negative electrode, reducing side reactions at the interfaces, thereby further improving the high-temperature intermittent cycling performance and alleviating the impedance growth during cycling of the electrochemical apparatus.

In some embodiments, the electrolyte satisfies at least one of the following conditions: (1) the electrolyte includes dihydro-3-[3-(triethoxysilyl)propyl]furan-2,5-dione, and based on the mass of the electrolyte, a mass percentage of the dihydro-3-[3-(triethoxysilyl)propyl]furan-2,5-dione is X %, where 1≤X≤2; (2) the electrolyte includes lithium tetraborate, and based on the mass of the electrolyte, a mass percentage of the lithium tetraborate is Y %, where 0.3≤Y≤0.6; or (3) the electrolyte includes bis(neopentyl glycolato)diboron, and based on the mass of the electrolyte, a mass percentage of the bis(neopentyl glycolato)diboron is Z %, where 0.3≤Z≤0.6.

Based on the above electrolyte solution, through cooperation of the components, the high-temperature intermittent cycling performance and kinetic performance of the electrochemical apparatus can be further improved, and the impedance growth during cycling can be further alleviated.

In some embodiments, the positive electrode active material layer includes lithium cobalt oxide, carbon black, and polyvinylidene fluoride (PVDF).

According to a second aspect, this application provides an electronic apparatus including the electrochemical apparatuses according to any one of the above embodiments.

### DETAILED DESCRIPTION

To make the objectives, technical solutions, and advantages of this application clearer, the following further describes this application in detail with reference to some embodiments. It should be understood that the specific embodiments described herein are only used to explain this application and are not intended to limit this application.

According to a first aspect, this application provides an electrochemical apparatus including a positive electrode, a negative electrode, and an electrolyte, where the positive electrode includes a positive electrode current collector and a positive electrode active material layer located on at least partial surface of the positive electrode current collector; the positive electrode active material layer has a compacted density of pd mg/cm³, where 2.60≤pd≤2.86; and based on a mass of the electrolyte, the electrolyte includes: ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %; where 1≤B/A≤8, and 5≤(E+D)/C≤14.

The inventors have found that in a positive electrode plate with a high compacted density, due to a low porosity of the electrode plate, the electrolyte is less likely to infiltrate the electrode plate, which affects lithium ion conduction in an electrochemical apparatus system. Moreover, a higher pressure is needed during preparation of the electrode plate with a high compacted density, which easily causes breakage of positive electrode active material particles, and side reactions between finer particles and the electrolyte increase accordingly, resulting in relatively high impedance growth of the electrochemical apparatus during cycling. Carboxylates (ethyl propionate and propyl propionate) and a linear ester (diethyl carbonate) are added to the electrolyte of this application, and the mass percentages of the carboxylates and the linear ester are controlled to satisfy the above relationship. This can significantly reduce viscosity of the electrolyte, accelerate lithium ion transport in a liquid phase, improve the infiltration of the electrolyte in the electrochemical apparatus, and optimize lithium ion conduction capability of the electrochemical apparatus, thereby improving the conductivity of the electrochemical apparatus, reducing internal resistance, and alleviating the impedance growth during cycling. In addition, controlling the electrolyte to include the above cyclic esters and adjusting the mass percentages of propylene carbonate and ethylene carbonate to satisfy the above relationship can change solvation structures of lithium ions and the composition of a solid electrolyte interphase film at the negative electrode. Through cooperation of the above cyclic esters with the above carboxylates and linear ester, the kinetic performance of the electrochemical apparatus can be further improved, and the rate performance can be improved. By adjusting the composition of the SEI film, side reactions at positive and negative electrode interfaces during cycling can also be suppressed, and the thickness growth of the SEI film at an interfacial layer can be reduced, thereby helping to reduce the impedance growth during cycling.

In some embodiments, 1≤B/A≤8, preferably 2≤B/A≤6. Exemplarily, the value of B/A may be 1, 1.6, 2, 2.7, 3.6, 4.6, 5.6, 6, 7.1, 7.4, 8, or a value within a range defined by any two of these values. Adjusting the mass percentages of ethylene carbonate and propylene carbonate to satisfy the above relationship can facilitate better cooperation between the two, achieving both improved kinetic performance and reduced impedance growth during cycling of the electrochemical apparatus.

In some embodiments, 5≤(E+D)/C≤14, preferably 8≤(E+D)/C≤10, more preferably 7≤(E+D)/C≤9.6. Exemplarily, the value of (E+D)/C may be 5, 5.8, 6.6, 7, 8.2, 9.6, 10.7, 11.1, 12.3, 13.5, 14, or a value within a range defined by any two of these values. Adjusting the mass percentages of the carboxylates and linear ester in the electrolyte of this application to satisfy the above relationship helps to further improve the kinetic performance and alleviate the impedance growth issue during cycling of the electrochemical apparatus.

In some embodiments, based on the mass of the electrolyte, a mass percentage of ethylene carbonate is A %, where 3≤A≤6. For example, A may be 3, 3.3, 3.5, 3.8, 4.1, 4.6, 4.8, 5.1, 5.4, 6, or a value within a range defined by any two of these values. Adjusting the mass percentage of ethylene carbonate in the electrolyte within the above range, in cooperation with other components, can further improve the kinetic performance of the electrochemical apparatus and reduce the impedance growth during cycling.

In some embodiments, based on the mass of the electrolyte, a mass percentage of propylene carbonate is B %, where 12≤B≤20. For example, B may be 12, 12.5, 13.2, 14.0, 14.8, 15.9, 17.1, 18, 18.7, 19.5, 20, or a value within a range defined by any two of these values. Adjusting the mass percentage of propylene carbonate to satisfy the above range, in cooperation with other components, can further improve the kinetic performance and alleviate the impedance growth issue of the electrochemical apparatus.

In some embodiments, based on the mass of the electrolyte, a mass percentage of diethyl carbonate is C %, where 5≤C≤8. For example, C may be 5, 5.2, 5.5, 5.8, 6.1, 6.6, 7, 7.3, 7.4, 7.7, 8, or a value within a range defined by any two of these values. Adjusting the mass percentage of diethyl carbonate to satisfy the above range, in cooperation with other components, can further improve the kinetic performance and alleviate the impedance growth issue of the electrochemical apparatus.

In some embodiments, based on the mass of the electrolyte, a mass percentage of ethyl propionate is D %, where 20≤D≤30. Exemplarily, D may be 20, 20.3, 22, 22.3, 23.9, 24.9, 26.3, 26.9, 28.4, 29.1, 30, or a value within a range defined by any two of these values. Adjusting the mass percentage of ethyl propionate to satisfy the above range, in cooperation with other components, can further improve the kinetic performance and alleviate the impedance growth issue of the electrochemical apparatus.

In some embodiments, based on the mass of the electrolyte, a mass percentage of propyl propionate is E %, where 20≤E≤40. Exemplarily, E may be 20, 20.4, 24.3, 25.5, 28.6, 29.4, 32.4, 34.6, 36.2, 39.4, 40, or a value within a range defined by any two of these values. Adjusting the mass percentage of propyl propionate to satisfy the above range, in cooperation with other components, can further improve the kinetic performance and alleviate the impedance growth issue of the electrochemical apparatus.

In some embodiments, the electrolyte includes fluoroethylene carbonate; and based on the mass of the electrolyte, a mass percentage of fluoroethylene carbonate is P %, where 5≤P 20, preferably 8≤P≤15. For example, P may be 5, 5.8, 8.3, 9.7, 11.6, 12.4, 14.8, 16.3, 16.9, 19.5, 20, or a value within a range defined by any two of these values. The inventors have found that fluoroethylene carbonate (FEC) is added to the electrolyte system of this application and can undergo reductive decomposition prior to ethylene carbonate at the negative electrode interface to form lithium fluoride (LiF). In cooperation with the above ethylene carbonate and propylene carbonate, the film-forming quality and stability of the SEI film can be optimized, side reactions at the interface can be reduced, and the reduction of the impedance growth during cycling can be facilitated. On the other hand, fluoroethylene carbonate in cooperation with the electrolyte system of this application can also reduce irreversible reactions at a positive electrode interface and alleviate the high-temperature gas production during storage, helping to improve the high-temperature intermittent cycling performance of the electrochemical apparatus. During high-temperature intermittent cycling, the electrochemical apparatus undergoes periodic charging, high-temperature storage, and discharging. This operating mode easily causes capacity decay of the electrochemical apparatus. The electrolyte containing FEC with the above mass percentage of this application can optimize the stability of the positive and negative electrode interfaces, thereby reducing the cycle decay and improving the high-temperature intermittent cycling performance of the electrochemical apparatus.

In some embodiments, the electrolyte includes 1,3,6-hexanetricarbonitrile; and based on the mass of the electrolyte, a mass percentage of 1,3,6-hexanetricarbonitrile is Q %, where 1≤Q≤6, preferably 2≤Q 4. Exemplarily, Q may be 1, 1.4, 1.6, 2.5, 2.8, 3.5, 4.1, 4.4, 5.2, 5.8, 6, or a value within a range defined by any two of these values. In this application, 1,3,6-hexanetricarbonitrile is added to the electrolyte. When the mass percentage of 1,3,6-hexanetricarbonitrile is adjusted to satisfy the above range, 1,3,6-hexanetricarbonitrile can complex with transition metal sites exposed on the surface of a positive electrode material, strengthening protection on the positive electrode, reducing the oxidative decomposition capability of the positive electrode material on the electrolyte under full charge conditions and other irreversible reactions at the positive electrode interface, and alleviating the gas production during storage and cycle decay rate in high-temperature intermittent cycling tests, thereby improving the high-temperature intermittent cycling performance of the electrochemical apparatus.

In some embodiments, the electrolyte includes 1,3-propane sultone; and based on the mass of the electrolyte, a mass percentage of 1,3-propane sultone is U %, where 1≤U≤4, preferably 2≤U≤3. Exemplarily, U may be 1, 1.3, 1.4, 1.9, 2.3, 2.6, 2.7, 3.1, 3.5, 4, or a value within a range defined by any two of these values. In this application, 1,3-propane sultone is added to the electrolyte and its mass percentage in the electrolyte is adjusted within the above range, decomposition and film formation of 1,3-propane sultone on the negative electrode surface can be facilitated, reductive decomposition of other electrolyte components at the negative electrode interface can be reduced, the gas production performance during storage in high-temperature intermittent cycling tests can be alleviated, and the high-temperature intermittent cycling performance of the electrochemical apparatus can be optimized.

In some embodiments, the electrolyte includes lithium hexafluorophosphate and a second lithium salt, the second lithium salt including lithium tetrafluoroborate or lithium difluorophosphate; and based on the mass of the electrolyte, a mass percentage of the second lithium salt is V %, where 0.1≤V≤0.8, preferably 0.2≤V≤0.4. Exemplarily, the value of V may be 0.1, 0.2, 0.3, 0.4, 0.5, 0.6, 0.7, 0.8, or a value within a range defined by any two of these values. The second lithium salt with the above mass percentage is added to the electrolyte. Lithium tetrafluoroborate can absorb residual hydrogen fluoride (HF) in the electrolyte, reduce corrosion of the positive electrode material by acidic substances, and participate in interface film formation on a positive electrode side to reduce oxidative decomposition of the electrolyte at high temperatures. Lithium difluorophosphate can undergo oxidative decomposition to form films on both the positive electrode and negative electrode, and the formed film substances can suppress irreversible side reactions of the electrolyte at the interfaces and protect electrode structural stability. After the two respectively closely cooperate with lithium hexafluorophosphate (LiPF₆), oxidative decomposition and film formation on the positive electrode and/or the negative electrode side can be achieved, the film-forming quality of the positive and negative electrode interface films can be optimized, side reactions between the electrolyte and the positive and negative electrode interfaces can be reduced, and the high-temperature intermittent cycling capacity decay rate and impedance growth during cycling can be alleviated.

In some embodiments, the electrolyte includes dihydro-3-[3-(triethoxysilyl)propyl]furan-2,5-dione; and based on the mass of the electrolyte, a mass percentage of dihydro-3-[3-(triethoxysilyl)propyl]furan-2,5-dione is X %, where 1≤X≤2. For example, X may be selected from 1, 1.1, 1.2, 1.3, 1.4, 1.5, 1.6, 1.7, 1.8, 1.9, 2, or a value within a range defined by any two of these values. In this application, dihydro-3-[3-(triethoxysilyl)propyl]furan-2,5-dione is added to the electrolyte, which can suppress side reactions at the positive electrode interface at high temperatures, and in particular, when its mass percentage is adjusted to satisfy the above range, the gas production performance during storage in high-temperature intermittent cycling can be further alleviated.

In some embodiments, the electrolyte includes lithium tetraborate; and based on the mass of the electrolyte, a mass percentage of lithium tetraborate is Y %, where 0.3≤Y≤0.6. For example, Y may be 0.3, 0.4, 0.5, 0.6, or a value within a range defined by any two of these values. In this application, lithium tetraborate is added to the electrolyte, which can participate in film formation on both the positive and negative electrodes, suppress side reactions at the positive electrode interface at high temperatures, and improve the high-temperature intermittent cycling performance of the electrochemical apparatus. When the mass percentage of lithium tetraborate in the electrolyte is adjusted to satisfy the above range, the kinetic performance can also be improved, and a capacity retention rate under high-temperature intermittent cycling can be further increased.

In some embodiments, the electrolyte includes bis(neopentyl glycolato)diboron; and based on the mass of the electrolyte, a mass percentage of bis(neopentyl glycolato)diboron is Z %, where 0.3≤Z≤0.6. For example, Z may be 0.3, 0.4, 0.5, 0.6, or a value within a range defined by any two of these values. In this application, bis(neopentyl glycolato)diboron is added to the electrolyte, which can form a film at the negative electrode interface, reduce side reactions of the electrolyte, and improve the high-temperature intermittent cycling performance of the electrochemical apparatus. When the mass percentage of bis(neopentyl glycolato)diboron in the electrolyte is adjusted to satisfy the above range, bis(neopentyl glycolato)diboron can also cooperate with the electrolyte system to improve the kinetic performance and enhance the rate performance of the electrochemical apparatus.

According to some embodiments of this application, the electrolyte further includes a lithium salt and a non-aqueous solvent. The lithium salt may include but is not limited to at least one of lithium bis(trifluoromethanesulfonyl)imide LiN(CF₃SO₂)₂ (LiTFSI), lithium bis(fluorosulfonyl)imide Li(N(SO₂F)₂) (LiFSI), lithium bis(oxalato)borate LiB(C₂O₄)₂ (LiBOB), lithium difluoro(oxalato)borate LiBF₂(C₂O₄) (LiDFOB), LiNO₃, LiClO₄, LiB(C₆H₅)₄, LiCH₃SO₃, LiCF₃SO₃, LiC(SO₂CF₃)₃, or Li₂SiF₆. This application imposes no limitation on the percentage of the lithium salt in the electrolyte, provided that the objectives of this application can be achieved. This application imposes no particular limitation on the non-aqueous solvent, provided that the objectives of this application can be achieved. For example, the non-aqueous solvent may include but is not limited to at least one of an ether compound or another organic solvent. The above ether compound may include but is not limited to at least one of 1,3-dioxolane (DOL), ethylene glycol dimethyl ether (1,2-dimethoxyethane, DME), dibutyl ether, tetraethylene glycol dimethyl ether, diethylene glycol dimethyl ether, 1,2-diethoxyethane, 1-ethoxy-1-methoxyethane, 2-methyltetrahydrofuran, or tetrahydrofuran. The above another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

This application imposes no particular limitation on the positive electrode, provided that the objectives of this application can be achieved. For example, the positive electrode includes a positive electrode current collector and a positive electrode active material layer located on at least one surface of the positive electrode current collector. The “positive electrode active material layer located on at least one surface of the positive electrode current collector” means that the positive electrode active material layer may be located on one surface of the positive electrode current collector in a thickness direction or on both surfaces of the positive electrode current collector in the thickness direction. It should be noted that the “surface” herein may be an entire region of the surface of the positive electrode current collector or a partial region of the surface of the positive electrode current collector, which is not particularly limited in this application, provided that the objectives of this application can be achieved.

This application imposes no particular limitation on the positive electrode current collector, provided that the objectives of this application can be achieved. For example, the positive electrode current collector may include an aluminum foil, an aluminum alloy foil, or a composite current collector (for example, an aluminum-carbon composite current collector). The composite current collector may be formed by forming a metal material (copper, copper alloy, nickel, nickel alloy, titanium, titanium alloy, silver, silver alloy, or the like) on a polymer substrate.

The positive electrode active material layer of this application includes a positive electrode active material. This application imposes no particular limitation on the type of the positive electrode active material, provided that the objectives of this application can be achieved. For example, the positive electrode active material may include at least one of lithium nickel cobalt manganese oxide (LiNi_{0.90}Co_{0.05}Mn_{0.05} O₂ (NCM955), NCM811, NCM622, NCM523, or NCM111), lithium nickel cobalt aluminate, lithium iron phosphate, lithium vanadium phosphate, lithium cobalt phosphate, lithium manganese phosphate, lithium manganese iron phosphate, a lithium-rich manganese-based material, lithium cobalt oxide (LiCoO₂), lithium iron silicate, lithium vanadium silicate, lithium cobalt silicate, lithium manganese silicate, spinel-type lithium manganese oxide, spinel-type lithium nickel manganese oxide, or lithium titanate. In this application, the positive electrode active material may further include a non-metal element. For example, the non-metal element includes at least one of fluorine, phosphorus, boron, chlorine, silicon, or sulfur. In this application, there is no particular limitation on the thicknesses of the positive electrode current collector and the positive electrode active material layer, provided that the objectives of this application can be achieved. For example, the thickness of the positive electrode current collector is 5 μm to 20 μm, and the thickness of the single-sided positive electrode active material layer is 30 μm to 120 μm.

In some embodiments, the positive electrode active material layer has a compacted density of pd mg/cm³, where 2.60≤pd≤2.86. For example, pd may be 2.6, 2.63, 2.64, 2.67, 2.69, 2.72, 2.75, 2.81, 2.83, 2.86, or a value within a range defined by any two of these values. When the compacted density of the positive electrode active material layer is within the above range, better cooperation with the electrolyte system can be achieved, the rate performance of the electrochemical apparatus can be improved, the impedance growth during cycling can be suppressed, and the high-temperature intermittent cycling performance can be improved.

In this application, the positive electrode active material layer may further include a positive electrode binder and a positive electrode conductive agent. This application imposes no particular limitation on the type of the positive electrode binder in the positive electrode active material layer, provided that the objectives of this application can be achieved. For example, the positive electrode binder may include but is not limited to at least one of polyvinylidene fluoride, polytetrafluoroethylene, polyolefins, sodium carboxymethyl cellulose, lithium carboxymethyl cellulose, modified polyvinylidene fluoride, modified styrene-butadiene rubber (SBR), or polyurethane. In some embodiments, the polyolefin binder includes at least one of polyethylene, polypropylene, polyolefin ester, polyolefin alcohol, or polyacrylic acid.

This application imposes no particular limitation on the type of the positive electrode conductive agent in the positive electrode active material layer, provided that the objectives of this application can be achieved. In some embodiments, the positive electrode conductive agent includes: a carbon-based material, for example, natural graphite, artificial graphite, carbon black, acetylene black, Ketjen black, or carbon fiber; a metal-based material, for example, metal powder or metal fiber of copper, nickel, aluminum, or silver; a conductive polymer, for example, a polyphenylene derivative; or a mixture thereof. This application imposes no particular limitation on a mass ratio of the positive electrode active material, positive electrode conductive agent, and positive electrode binder in the positive electrode active material layer, and those skilled in the art may select according to actual needs, provided that the objectives of this application can be achieved. For example, a loading amount of the positive electrode active material in the positive electrode plate is 4.0 mg/cm² to 10.0 mg/cm².

In some more preferred embodiments, the positive electrode active material layer includes lithium cobalt oxide, carbon black, and polyvinylidene fluoride.

This application imposes no particular limitation on the negative electrode plate, provided that the objectives of this application can be achieved. For example, the negative electrode plate includes a negative electrode current collector and a negative electrode active material layer disposed on at least one surface of the negative electrode current collector. In this application, the negative electrode active material layer may be disposed on one surface of the negative electrode current collector in a thickness direction or on both surfaces of the negative electrode current collector in the thickness direction. It should be noted that the “surface” herein may be an entire region of the negative electrode current collector or a partial region of the negative electrode current collector, which is not particularly limited in this application, provided that the objectives of this application can be achieved.

This application imposes no particular limitation on the negative electrode current collector, provided that the objectives of this application can be achieved. For example, the negative electrode current collector may include but is not limited to a copper foil, a copper alloy foil, a nickel foil, a stainless steel foil, a titanium foil, foamed nickel, foamed copper, or a composite current collector (for example, a carbon-coated copper composite current collector, a nickel-copper composite current collector, or a titanium-copper composite current collector). In this application, there is no particular limitation on the thicknesses of the negative electrode current collector and negative electrode active material layer, provided that the objectives of this application can be achieved.

The negative electrode active material layer of this application includes a negative electrode active material. The negative electrode active material may include but is not limited to at least one of graphite, mesocarbon microbeads (MCMB), hard carbon, soft carbon, silicon, silicon-carbon composite, SiOₓ (0.5≤x≤1.6), Li—Sn alloy, Li—Sn—O alloy, Sn, SnO, SnO₂, spinel-structured lithium titanate-lithiated TiO₂—Li₄Ti₅O₁₂, Li—Al alloy, or metallic lithium.

The negative electrode active material layer in this application may further include a negative electrode binder and a negative electrode conductive agent, or the negative electrode active material layer may further include a negative electrode binder, a negative electrode conductive agent, and a thickener. This application imposes no particular limitation on the types of the negative electrode binder and the negative electrode conductive agent, provided that the objectives of this application can be achieved. For example, the negative electrode binder may include but is not limited to at least one of the above positive electrode binders, and the negative electrode conductive agent may include but is not limited to at least one of the above positive electrode conductive agents. This application imposes no particular limitation on the type of the thickener, provided that the objectives of this application can be achieved. For example, the thickener may include but is not limited to at least one of sodium carboxymethyl cellulose or carboxymethyl cellulose. This application imposes no particular limitation on a mass ratio of the negative electrode active material, negative electrode conductive agent, negative electrode binder, and thickener in the negative electrode active material layer, and those skilled in the art may select according to actual needs, provided that the objectives of this application can be achieved.

There is no particular limitation on the electrochemical apparatus of this application. The electrochemical apparatus may include any apparatus where electrochemical reactions occur, for example, a secondary battery. The following takes a secondary battery as an example to illustrate this application in combination with some embodiments of this application. There is no particular limitation on the secondary battery of this application. For example, the secondary battery may include but is not limited to a lithium-ion secondary battery (also called a lithium-ion battery) or a sodium-ion secondary battery.

The secondary battery of this application further includes a separator. There is no particular limitation on the material and shape of the separator used in the secondary battery of this application, which may be any technology disclosed in the prior art. In some embodiments, the separator includes a polymer, an inorganic substance, or the like formed from a material stable to the electrolyte of this application.

For example, the separator may include a substrate layer and a surface treatment layer. The substrate layer is a non-woven fabric, film, or composite film having a porous structure. The material of the substrate layer is selected from at least one of polyethylene, polypropylene, polyethylene terephthalate, or polyimide. Specifically, a polypropylene porous film, a polyethylene porous film, a polypropylene non-woven fabric, a polyethylene non-woven fabric, or a polypropylene-polyethylene-polypropylene porous composite film may be used.

At least one surface of the substrate layer is provided with a surface treatment layer, where the surface treatment layer may be a polymer layer or an inorganic substance layer, or may be a layer formed by mixing a polymer and an inorganic substance. The inorganic substance layer includes inorganic particles and a binder. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinylether, polymethyl methacrylate, polytetrafluoroethylene, or polyhexafluoropropylene. The polymer layer contains a polymer. The material of the polymer is selected from at least one of polyamide, polyacrylonitrile, acrylate polymer, polyacrylic acid, polyacrylate salt, polyvinylpyrrolidone, polyvinylether, polyvinylidene fluoride, or poly(vinylidene fluoride-hexafluoropropylene).

The secondary battery of this application further includes a packaging bag for accommodating the positive electrode, the negative electrode, the separator, and electrolyte, as well as other components known in the field of secondary batteries, and this application imposes no limitation on the above other components. The packaging bag is not particularly limited in this application, which may be any packaging bag known in the art, provided that the objectives of this application can be achieved.

The preparation process of the secondary battery of this application is well known to those skilled in the art and is not particularly limited in this application. For example, it may include but is not limited to the following steps: stacking the positive electrode plate, the separator, and the negative electrode plate in sequence, and performing an operation such as winding or folding as needed to obtain an electrode assembly with a wound structure, placing the electrode assembly into the packaging bag, injecting the electrolyte into the packaging bag, and sealing to obtain the secondary battery; or stacking the positive electrode plate, the separator, and the negative electrode plate in sequence, then fixing four corners of an entire laminated structure with an adhesive tape to obtain an electrode assembly with a laminated structure, placing the electrode assembly into the packaging bag, injecting the electrolyte into the packaging bag, and sealing to obtain the secondary battery. In addition, an overcurrent prevention element, a guide plate, and the like may also be placed in the packaging bag as needed to prevent pressure rise, overcharge, and overdischarge inside the secondary battery.

According to a second aspect, this application provides an electronic apparatus including the electrochemical apparatus according to the first aspect.

The electronic apparatus of this application is not particularly limited, which may be any electronic apparatus known in the prior art. For example, the electronic apparatus may include but is not limited to a notebook computer, a pen-input computer, a mobile computer, an e-book player, a portable telephone, a portable fax machine, a portable copier, a portable printer, a stereo headset, a video recorder, a liquid crystal television, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a game console, a clock, a power tool, a flash lamp, a camera, a large household battery, or a lithium-ion capacitor.

The following takes a lithium-ion battery as an example to illustrate the solutions of this application with reference to specific examples. Unless otherwise specified, the raw materials used in the following examples are all commercially available ordinary products, and the apparatuses or devices used are all purchased from conventional commercial channels. Various tests and evaluations are carried out according to the following methods. In addition, unless otherwise specified, “parts” and “%” are based on mass.

### Test for High-Temperature Intermittent Cycling Performance:

The lithium-ion battery of each of the examples and comparative examples was left standing at a test temperature of 45° C. for 2 h to reach thermal equilibrium, and then an initial thickness d₀ of the lithium-ion battery was tested. Then, the thermally equilibrated lithium-ion battery was subjected to the following test process: the lithium-ion battery was charged at a constant current of 1 C to a cut-off voltage of 4.52 V, then charged at a constant voltage until the current was less than or equal to 0.05 C, and then left standing and stored at 45° C. for 24 h. The lithium-ion battery after storage was discharged at a constant current of 0.5 C to 3 V, and then left standing at 45° C. for 5 min. The test process performed once was taken as one cycle. The above test process was repeatedly executed, and a thickness d₁ of the lithium-ion battery was tested each cycle. The number of cycles obtained when the thickness d₁ of the lithium-ion battery was greater than or equal to 120% of d₀ was recorded as the number of cycles for high-temperature intermittent cycling gas production. Under high-temperature intermittent cycling conditions, when internal side reactions of the lithium-ion battery were difficult to suppress, gas production occurs. After gas production, the lithium-ion battery swelled rapidly, causing the thickness d₁ to exceed 120% of the initial thickness do. Therefore, a large number of cycles for high-temperature intermittent cycling gas production of the lithium-ion battery indicated higher capability of suppressing internal gas production under high-temperature intermittent cycling conditions, that was, the high-temperature intermittent cycling performance of the lithium-ion battery was better.

Alternatively, the lithium-ion battery of each of the examples and comparative examples was charged at 25° C. at a constant current of 1 C to a cut-off voltage of 4.52 V, then charged at a constant voltage until the current was less than or equal to 0.05 C. After charged, the lithium-ion battery was discharged at a constant current of 1 C to a cut-off voltage of 3 V, and an initial discharge capacity was recorded. Then, the lithium-ion battery of each of the examples and comparative examples was left standing at a test temperature of 45° C. for 2 h to reach thermal equilibrium, and the thermally equilibrated lithium-ion battery was subjected to the following test process: the lithium-ion battery was charged at a constant current of 1 C to a cut-off voltage of 4.52 V, then charged at a constant voltage until the current was less than or equal to 0.05 C, and then left standing and stored at 45° C. for 24 h. The lithium-ion battery after storage was discharged at a constant current of 0.5 C to 3 V, and then left standing at 45° C. for 5 min. The test process performed once was taken as one cycle. The above test process was repeatedly executed, and a discharge capacity obtained when the number of high-temperature intermittent cycles of the lithium-ion battery reached 120 cycles was recorded. High-temperature intermittent cycling capacity retention rate (%)=discharge capacity after 120 cycles/initial discharge capacity×100%.

### Test for Kinetic (Rate) Performance:

The lithium-ion battery of each of the examples and comparative examples was charged at a constant current of 1 C to a cut-off voltage of 4.52 V, then charged at a constant voltage until the current was less than or equal to 0.05 C. After charged, the lithium-ion battery was discharged at a constant current of 1 C to a cut-off voltage of 3 V, and a discharge capacity at a rate of 1 C was recorded. Then, the lithium-ion battery was charged at a constant current of 1 C to a cut-off voltage of 4.52 V, and then charged at a constant voltage until the current was less than or equal to 0.05 C. After charged, the lithium-ion battery was discharged at a constant current of 2 C to a cut-off voltage of 3 V, and a discharge capacity at a rate of 2 C was recorded. Percentage R₁ of discharge capacity at 2 C (%)=[(discharge capacity at rate of 1 C−discharge capacity at rate of 2 C)/discharge capacity at rate of 1 C]×100.

### Test for Cycling Impedance:

The lithium-ion battery of each of the examples and comparative examples was charged and discharged at 25° C. under the following conditions: the lithium-ion battery was charged at a constant current of 1 C to a cut-off voltage of 4.52 V, and then charged at a constant voltage until the current was less than or equal to 0.05 C. The lithium-ion battery was discharged at a constant current of 0.5 C to a cut-off voltage of 3 V. After three charge-discharge cycles were performed according to the above charge-discharge process, based on the last discharge capacity, the battery was set to SOC 50%. Then, direct current internal resistance was measured by voltage drop displayed when a discharge pulse of 2.5 C was applied for 10 seconds (a PNE-0506 charge-discharge apparatus was used), and the resistance at this point was defined as initial resistance.

After 100 charge-discharge cycles were performed, the lithium-ion battery was moved to 25° C., and SOC was set to 50%. Then, resistance after 100 cycles was measured by voltage drop displayed when a discharge pulse of 2.5 C was applied for 10 seconds using the PNE-0506 charge-discharge apparatus. Cycling resistance increase rate R₂ (%)=[(resistance after 100 cycles−initial resistance)/initial resistance]×100.

### Example 1-1

### ≤Preparation of Electrolyte>

In a dry argon atmosphere glove box, lithium hexafluorophosphate (LiPF₆) as a supporting electrolyte was dissolved in a solution including dimethyl carbonate (DMC), ethyl acetate (EA), ethylene carbonate (EC), propylene carbonate (PC), diethyl carbonate (DEC), ethyl propionate (EP), and propyl propionate (PP). Based on a mass of the electrolyte, a mass percentage of lithium hexafluorophosphate was 12%; mass percentages of ethylene carbonate, propylene carbonate, diethyl carbonate, ethyl propionate, and propyl propionate were as shown in Table 1 below; the balance was dimethyl carbonate and ethyl acetate; and a mass ratio of dimethyl carbonate to ethyl acetate was 1:3.

### ≤Preparation of Negative Electrode Plate>

Artificial graphite as a negative electrode active material, Super P as a negative electrode conductive agent, sodium carboxymethyl cellulose (CMC-Na) as a thickener, and styrene-butadiene rubber (SBR) as a negative electrode binder were mixed at a mass ratio of 96.4:1.5:0.5:1.6, and then deionized water was added as a solvent to prepare a negative electrode slurry with a solid content of 30 wt %. The negative electrode slurry was uniformly applied on one surface of a copper foil as a negative electrode current collector with a thickness of 10 μm and dried at 110° C. to obtain a negative electrode plate with one surface coated with a negative electrode active material layer. Then, the above steps were repeated on another surface of the negative electrode plate to obtain a negative electrode plate with both surfaces coated with negative electrode active material layers. After coated, the negative electrode plate was cold-pressed and cut into a negative electrode plate with a specification of 76.6 mm×875 mm for later use.

### ≤Preparation of Positive Electrode Plate>

Lithium cobalt oxide (LiCoO₂) as a positive electrode active material, polyvinylidene fluoride (PVDF) as a positive electrode binder, and Super P as a positive electrode conductive agent were mixed at a mass ratio of 97:1.6:1.4, and then N-methylpyrrolidone (NMP) was added as a solvent to prepare a slurry with a solid content of 75 wt %, and the slurry was stirred well. The positive electrode slurry was uniformly applied on one surface of an aluminum foil as a positive electrode current collector with a thickness of 10 μm and dried at 110° C. to obtain a positive electrode plate with one surface coated with a positive electrode active material. Then, the above steps were repeated on another surface of the positive electrode plate to obtain a positive electrode plate with both surfaces coated with positive electrode active materials. After coated, the positive electrode plate was cold-pressed, where pressure was adjusted so that a compacted density pd mg/cm³ of the positive electrode active material layer satisfied Table 1. Then, the positive electrode plate was cut into a positive electrode plate with a specification of 74 mm×867 mm for later use.

### ≤Separator>

A polyethylene-polypropylene film with a thickness of 7 μm was used.

### <Preparation of Lithium-Ion Battery>

The positive electrode plate, separator, and negative electrode plate prepared above were stacked in sequence, so that the separator was located between the positive electrode plate and negative electrode plate for separation. Then, the resulting stack was wound to obtain an electrode assembly. After tab welding, the electrode assembly was placed into an aluminum-plastic film packaging shell and dried in a vacuum oven at 85° C. for 12 hours to remove moisture. Then, the electrolyte prepared above was injected. Processes such as vacuum sealing, standing, and formation were performed to obtain a lithium-ion battery.

### Examples 1-2 to 1-22 and Comparative Examples 1-1 to 1-6

These examples and comparative examples differed from Example 1-1 only in that the parameters were adjusted according to Table 1. The performance test results of the examples and comparative examples are shown in Table 1.

TABLE 1

| | | Mass | Mass | | | | | | | |
|---|---|---|---|---|---|---|---|---|---|---|
| | | percentage | percentage | | Mass | Mass | Mass | | Percentage | Cycling |
| | | A of | B of | | percentage | percentage | percentage | | R₁ of | resistance |
| | Compacted | ethylene | propylene | | C of diethyl | D of ethyl | E of propyl | | discharge | increase |
| | density pd | carbonate | carbonate | | carbonate | propionate | propionate | (E + D)/ | capacity at | rate R₂ |
| No. | (mg/cm³) | (%) | (%) | B/A | (%) | (%) | (%) | C | 2 C (%) | (%) |
| Example 1-1 | 2.60 | 8 | 8 | 1 | 9 | 18 | 36 | 6 | 70% | 7.7% |
| Example 1-2 | 2.60 | 6 | 8.04 | 1.34 | 9 | 18 | 36 | 6 | 72% | 7.8% |
| Example 1-3 | 2.60 | 4 | 8 | 2 | 9 | 18 | 36 | 6 | 74% | 7.9% |
| Example 1-4 | 2.60 | 3 | 8.01 | 2.67 | 9 | 18 | 36 | 6 | 76% | 8.0% |
| Example 1-5 | 2.60 | 2 | 8 | 4 | 9 | 18 | 36 | 6 | 78% | 8.0% |
| Example 1-6 | 2.60 | 1.34 | 8.0 | 6 | 9 | 18 | 36 | 6 | 78% | 8.1% |
| Example 1-7 | 2.60 | 1 | 8 | 8 | 9 | 18 | 36 | 6 | 76% | 8.4% |
| Example 1-8 | 2.60 | 3 | 12 | 4 | 9 | 18 | 36 | 6 | 72% | 7.9% |
| Example 1-9 | 2.60 | 5 | 20 | 4 | 9 | 18 | 36 | 6 | 68% | 7.7% |
| Example 1-10 | 2.60 | 4 | 16 | 4 | 9 | 18 | 36 | 6 | 65% | 7.8% |
| Example 1-11 | 2.60 | 3 | 12 | 4 | 8 | 18 | 36 | 6.75 | 72% | 8.0% |
| Example 1-12 | 2.60 | 3 | 12 | 4 | 7.2 | 18 | 36 | 7.5 | 75% | 8.1% |
| Example 1-13 | 2.60 | 3 | 12 | 4 | 5.625 | 18 | 36 | 9.6 | 79% | 8.3% |
| Example 1-14 | 2.60 | 3 | 12 | 4 | 5 | 18 | 36 | 10.8 | 80% | 8.8% |
| Example 1-15 | 2.60 | 3 | 12 | 4 | 4 | 20 | 36 | 14 | 83% | 9.2% |
| Example 1-16 | 2.60 | 3 | 12 | 4 | 7.625 | 25 | 36 | 8 | 85% | 9.2% |
| Example 1-17 | 2.60 | 3 | 12 | 4 | 6.25 | 30 | 20 | 8 | 86% | 9.5% |
| Example 1-18 | 2.60 | 3 | 12 | 4 | 6.25 | 22 | 28 | 8 | 85% | 9.4% |
| Example 1-19 | 2.60 | 3 | 12 | 4 | 5.75 | 22 | 24 | 8 | 84% | 9.2% |
| Example 1-20 | 2.60 | 3 | 12 | 4 | 7.75 | 22 | 40 | 8 | 86% | 9.5% |
| Example 1-21 | 2.75 | 3 | 12 | 4 | 5.75 | 22 | 24 | 8 | 82% | 9.2% |
| Example 1-22 | 2.86 | 3 | 12 | 4 | 5.75 | 22 | 24 | 8 | 80% | 9.3% |
| Comparative | 2.56 | 8 | 8 | 1 | 9 | 18 | 36 | 6 | 72% | 7.7% |
| Example 1-1 | | | | | | | | | | |
| Comparative | 2.90 | 8 | 8 | 1 | 9 | 18 | 36 | 6 | 64% | 8.7% |
| Example 1-2 | | | | | | | | | | |
| Comparative | 2.60 | 10 | 8 | 0.8 | 9 | 18 | 36 | 6 | 68% | 7.6% |
| Example 1-3 | | | | | | | | | | |
| Comparative | 2.60 | 0.9 | 8 | 8.5 | 9 | 18 | 36 | 6 | 65% | 8.5% |
| Example 1-4 | | | | | | | | | | |
| Comparative | 2.60 | 8 | 8 | 1 | 13.5 | 18 | 36 | 4 | 68% | 7.4% |
| Example 1-5 | | | | | | | | | | |
| Comparative | 2.60 | 8 | 8 | 1 | 3.6 | 18 | 36 | 15 | 75% | 8.4% |
| Example 1-6 | | | | | | | | | | |

It can be seen from Table 1 that the electrolyte of this application is adjusted to include ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %. Controlling the mass percentages of the components to satisfy 1≤B/A≤8 and 5≤(E+D)/C≤14 can improve the kinetic performance and alleviate the impedance growth issue of a lithium-ion battery with a high positive electrode compacted density. Although Comparative Example 1-1 has a relatively high discharge capacity retention rate at 2 C, its positive electrode compacted density is relatively low, which affects overall energy density and leads to a relatively low total discharge capacity. The solution of this application can balance the kinetic performance and the impedance growth issue under a high positive electrode compacted density, achieving a relatively high overall yield rate.

In particular, the mass percentages of the components respectively satisfying 3≤A≤6, 12≤B≤20, 5≤C≤8, 20≤D≤30, and/or 20≤E≤40 can further improve the kinetic performance and alleviate the impedance growth issue of the lithium-ion battery. In particular, the mass percentages of ethylene carbonate and propylene carbonate satisfying 2≤B/A≤6 can more significantly improve the kinetic performance and alleviate the impedance growth issue of the lithium-ion battery. More preferably, the mass percentages of diethyl carbonate, ethyl propionate, and propyl propionate satisfying 6.6≤(E+D)/C≤9.2 can further improve the kinetic performance and alleviate the impedance growth issue of the lithium-ion battery.

### Examples 2-1 to 2-20

These examples differed from Example 1-21 only in that the parameters shown for the electrolyte were adjusted according to Table 2. In the preparation processes of the electrolytes of Examples 2-1 to 2-20, the corresponding mass percentages of substances were also dissolved in the solution including dimethyl carbonate (DMC), ethyl acetate (EA), ethylene carbonate (EC), propylene carbonate (PC), diethyl carbonate (DEC), ethyl propionate (EP), and propyl propionate (PP). The performance test results of the examples are shown in Table 2.

TABLE 2

| | | Mass | | | | | | |
|---|---|---|---|---|---|---|---|---|
| | | percentage Q | Mass percentage | | | High-temperature | Percentage | Cycling |
| | Mass | of 1,3,6- | U of 1,3- | Type of | Percentage | intermittent | R₁ of | resistance |
| | percentage | hexanetricar- | propane | second | V of second | cycling gas | discharge | increase |
| | P of FEC | bonitrile | sultone | lithium | lithium salt | production cycles | capacity at | rate R₂ |
| No. | (%) | (%) | (%) | salt | (%) | (cycle) | 2 C (%) | (%) |
| Example 2-1 | 5 | \ | \ | \ | \ | 132 | 82% | 9.2% |
| Example 2-2 | 8 | \ | \ | \ | \ | 134 | 80% | 9.1% |
| Example 2-3 | 15 | \ | \ | \ | \ | 128 | 80% | 9.0% |
| Example 2-4 | 20 | \ | \ | \ | \ | 109 | 79% | 8.8% |
| Example 2-5 | 11 | 1 | \ | \ | \ | 136 | 76% | 8.8% |
| Example 2-6 | 11 | 2 | \ | \ | \ | 140 | 79% | 8.9% |
| Example 2-7 | 11 | 4 | \ | \ | \ | 147 | 78% | 8.7% |
| Example 2-8 | 11 | 6 | \ | \ | \ | 151 | 77% | 8.5% |
| Example 2-9 | 13 | 3 | 1 | \ | \ | 143 | 72% | 8.6% |
| Example 2-10 | 13 | 3 | 2 | \ | \ | 145 | 77% | 8.6% |
| Example 2-11 | 13 | 3 | 3 | \ | \ | 149 | 77% | 8.5% |
| Example 2-12 | 13 | 3 | 4 | \ | \ | 148 | 76% | 8.3% |
| Example 2-13 | 12 | 3 | 2 | Lithium | 0.1 | 145 | 73% | 8.6% |
| | | | | tetrafluoroborate | | | | |
| Example 2-14 | 12 | 3 | 2 | Lithium | 0.2 | 146 | 77% | 8.5% |
| | | | | tetrafluoroborate | | | | |
| Example 2-15 | 12 | 3 | 2 | Lithium | 0.4 | 145 | 77% | 8.4% |
| | | | | tetrafluoroborate | | | | |
| Example 2-16 | 12 | 3 | 2 | Lithium | 0.8 | 141 | 76% | 8.2% |
| | | | | tetrafluoroborate | | | | |
| Example 2-17 | 12 | 3 | 2 | Lithium | 0.1 | 145 | 73% | 8.3% |
| | | | | difluorophosphate | | | | |
| Example 2-18 | 12 | 3 | 2 | Lithium | 0.2 | 147 | 77% | 8.5% |
| | | | | difluorophosphate | | | | |
| Example 2-19 | 12 | 3 | 2 | Lithium | 0.4 | 146 | 76% | 8.4% |
| | | | | difluorophosphate | | | | |
| Example 2-20 | 12 | 3 | 2 | Lithium | 0.8 | 140 | 75% | 8.2% |
| | | | | difluorophosphate | | | | |

It can be seen from Table 2 that adding fluoroethylene carbonate to the electrolyte system of this application and adjusting its mass percentage P % to satisfy 5≤P 20 can further improve the high-temperature intermittent cycling performance and capability of suppressing the impedance growth during cycling of the lithium-ion battery. In particular, when 8≤P≤15 is satisfied, the high-temperature intermittent cycling performance and capability of suppressing the impedance growth during cycling of the lithium-ion battery can be more significantly improved.

In particular, adding 1,3,6-hexanetricarbonitrile to the electrolyte and adjusting its mass percentage Q % to satisfy 1≤Q≤6 can further improve the high-temperature intermittent cycling performance and capability of suppressing the impedance growth during cycling of the lithium-ion battery. In particular, when 2≤Q≤4 is satisfied, the high-temperature intermittent cycling performance and capability of suppressing the impedance growth during cycling of the lithium-ion battery can be further improved.

In particular, when the electrolyte includes 1,3-propane sultone and its mass percentage U % satisfies 1≤U≤4, the high-temperature intermittent cycling performance and capability of suppressing the impedance growth during cycling of the lithium-ion battery can be significantly improved. In particular, when the electrolyte satisfies 2≤U≤3, the impedance growth issue during cycling of the lithium-ion battery can be further alleviated.

In particular, the electrolyte includes the second lithium salt, and the second lithium salt includes lithium tetrafluoroborate or lithium difluorophosphate. When the mass percentage V % of the second lithium salt is adjusted to satisfy 0.1≤V≤0.8, the high-temperature intermittent cycling performance of the lithium-ion battery can be further improved, and the impedance growth issue during cycling can be further alleviated. In particular, when 0.2≤V≤0.4 is satisfied, the high-temperature intermittent cycling performance of the lithium-ion battery can be significantly improved, and the impedance growth issue during cycling can be significantly alleviated.

### Examples 3-1 to 3-10

These examples differed from Example 2-18 only in that the parameters shown for the electrolyte were adjusted according to Table 3. In the preparation processes of the electrolytes of Examples 3-1 to 3-10, the corresponding mass percentages of substances were also dissolved in a solution including dimethyl carbonate (DMC), ethyl acetate (EA), ethylene carbonate (EC), propylene carbonate (PC), diethyl carbonate (DEC), ethyl propionate (EP), and propyl propionate (PP). The performance test results of the examples are shown in Table 3.

TABLE 3

| | | | | High- | | |
|---|---|---|---|---|---|---|
| | Mass | Mass | | temperature | | |
| | percentage X of | percentage | | intermittent | Percentage | Cycling |
| | dihydro-3-[3- | Y of | Mass percentage of | cycling | R₁ of | resistance |
| | (triethoxysilyl)pro- | lithium | bis(neopentyl | capacity | discharge | increase |
| | pyl]furan-2,5- | tetraborate | glycolato)diboron | retention | capacity at | rate |
| No. | dione (%) | (%) | (%) | rate (%) | 2 C (%) | R₂ (%) |
| Example 2-18 | \ | \ | \ | 58% | 71% | 7.4% |
| Example 3-1 | 1 | \ | \ | 61% | 75% | 8.40% |
| Example 3-2 | 1.3 | \ | \ | 63% | 75% | 8.20% |
| Example 3-3 | 2 | \ | \ | 62% | 72% | 8.10% |
| Example 3-4 | \ | 0.3 | \ | 63% | 77% | 8.50% |
| Example 3-5 | \ | 0.4 | \ | 65% | 79% | 8.50% |
| Example 3-6 | \ | 0.6 | \ | 62% | 80% | 8.80% |
| Example 3-7 | \ | \ | 0.3 | 62% | 75% | 8.30% |
| Example 3-8 | \ | \ | 0.5 | 64% | 74% | 8.10% |
| Example 3-9 | \ | \ | 0.6 | 61% | 71% | 8.10% |
| Example 3-10 | 1.3 | 0.4 | 0.5 | 67% | 79% | 8.00% |

It can be seen from Table 3 that further adding at least one of dihydro-3-[3-(triethoxysilyl)propyl]furan-2,5-dione, lithium tetraborate, or bis(neopentyl glycolato)diboron to the electrolyte and adjusting their respective mass percentages to satisfy 1≤X≤2, 0.3≤Y≤0.6, and 0.3≤Z≤0.6 can further improve the high-temperature intermittent cycling performance and alleviate the impedance growth during cycling. In particular, when the electrolyte simultaneously includes the above three substances, interaction among the components can more significantly improve the high-temperature intermittent cycling performance and kinetic performance of the lithium-ion battery, and alleviate the impedance growth during cycling.

The above are merely preferred embodiments of this application and are not intended to limit this application. Any modifications, equivalent replacements, and improvements made within the principles of this application shall be included in the protection scope of this application.

What is claimed is:

1. An electrochemical apparatus, comprising a positive electrode, a negative electrode, and an electrolyte; wherein the positive electrode comprises a positive electrode current collector and a positive electrode active material layer located on at least a part of a surface of the positive electrode current collector; a compacted density of the positive electrode active material layer is pd mg/cm³, wherein 2.60≤pd≤2.86; and
the electrolyte comprises ethylene carbonate, propylene carbonate, diethyl carbonate, ethyl propionate and propyl propionate; based on a mass of the electrolyte, a mass percentage of ethylene carbonate is A %, a mass percentage of propylene carbonate is B %, a mass percentage of diethyl carbonate is C %, a mass percentage of ethyl propionate is D %, and a mass percentage of propyl propionate is E %; wherein
$$1 \leq B / A \leq 8 , and 5 \leq ( E + D ) / C \leq 14 .$$

2. The electrochemical apparatus according to claim 1, wherein the electrolyte satisfies at least one of the following conditions:
$$3 \leq A \leq 6 ; \qquad ( 1 )$$
$$12 \leq B \leq 20 ; \qquad ( 2 )$$
$$5 \leq C \leq 8 ; \qquad ( 3 )$$
$$20 \leq D \leq 30 ; \qquad ( 4 )$$
$$20 \leq E \leq 40 ; \qquad ( 5 )$$
$$2 \leq B / A \leq 6 ; or \qquad ( 6 )$$
$$8 \leq ( E + D ) / C \leq 10 . \qquad ( 7 )$$

3. The electrochemical apparatus according to claim 1, wherein the electrolyte further comprises fluoroethylene carbonate; and based on the mass of the electrolyte, a mass percentage of the fluoroethylene carbonate is P %, wherein 5≤P≤20.

4. The electrochemical apparatus according to claim 2, wherein the electrolyte further comprises fluoroethylene carbonate; and based on the mass of the electrolyte, a mass percentage of the fluoroethylene carbonate is P %, wherein 5≤P≤20.

5. The electrochemical apparatus according to claim 3, wherein the electrolyte further comprises 1,3,6-hexanetricarbonitrile; and based on the mass of the electrolyte, a mass percentage of the 1,3,6-hexanetricarbonitrile is Q %, wherein 1≤Q≤6.

6. The electrochemical apparatus according to claim 4, wherein the electrolyte further comprises 1,3,6-hexanetricarbonitrile; and based on the mass of the electrolyte, a mass percentage of the 1,3,6-hexanetricarbonitrile is Q %, wherein 1≤Q≤6.

7. The electrochemical apparatus according to claim 5, wherein the electrolyte further comprises 1,3-propane sultone; and based on the mass of the electrolyte, a mass percentage of the 1,3-propane sultone is U %, wherein 1≤U≤4.

8. The electrochemical apparatus according to claim 6, wherein the electrolyte further comprises 1,3-propane sultone; and based on the mass of the electrolyte, a mass percentage of the 1,3-propane sultone is U %, wherein 1≤U≤4.

9. The electrochemical apparatus according to claim 7, wherein the electrolyte satisfies at least one of the following conditions:
$$8 \leq P \leq 15 ; \qquad ( 1 )$$
$$2 \leq Q \leq 4 ; or \qquad ( 2 )$$
$$2 \leq U \leq 3 . \qquad ( 3 )$$

10. The electrochemical apparatus according to claim 8, wherein the electrolyte satisfies at least one of the following conditions:
$$8 \leq P \leq 15 ; \qquad ( 1 )$$
$$2 \leq Q \leq 4 ; or \qquad ( 2 )$$
$$2 \leq U \leq 3 . \qquad ( 3 )$$

11. The electrochemical apparatus according to claim 5, wherein the electrolyte further comprises lithium hexafluorophosphate and a second lithium salt, the second lithium salt comprising lithium tetrafluoroborate or lithium difluorophosphate; and
based on the mass of the electrolyte, a mass percentage of the second lithium salt is V %, wherein 0.1≤V≤0.8.

12. The electrochemical apparatus according to claim 7, wherein the electrolyte further comprises lithium hexafluorophosphate and a second lithium salt, the second lithium salt comprising lithium tetrafluoroborate or lithium difluorophosphate; and
based on the mass of the electrolyte, a mass percentage of the second lithium salt is V %, wherein 0.1≤V≤0.8.

13. The electrochemical apparatus according to claim 9, wherein the electrolyte further comprises lithium hexafluorophosphate and a second lithium salt, the second lithium salt comprising lithium tetrafluoroborate or lithium difluorophosphate; and
based on the mass of the electrolyte, a mass percentage of the second lithium salt is V %, wherein 0.1≤V≤0.8.

14. The electrochemical apparatus according to claim 5, wherein the electrolyte satisfies at least one of the following conditions:
(1) the electrolyte comprises dihydro-3-[3-(triethoxysilyl)propyl]furan-2,5-dione; and based on the mass of the electrolyte, a mass percentage of dihydro-3-[3-(triethoxysilyl)propyl]furan-2,5-dione is X %, wherein 1≤X≤2;
(2) the electrolyte comprises lithium tetraborate; and based on the mass of the electrolyte, a mass percentage of the lithium tetraborate is Y %, wherein 0.3≤Y≤0.6; or
(3) the electrolyte comprises bis(neopentyl glycolato)diboron; and based on the mass of the electrolyte, a mass percentage of the bis(neopentyl glycolato)diboron is Z %, wherein 0.3≤Z≤0.6.

15. The electrochemical apparatus according to claim 7, wherein the electrolyte satisfies at least one of the following conditions:
(1) the electrolyte comprises dihydro-3-[3-(triethoxysilyl)propyl]furan-2,5-dione; and based on the mass of the electrolyte, a mass percentage of dihydro-3-[3-(triethoxysilyl)propyl]furan-2,5-dione is X %, wherein 1≤X≤2;
(2) the electrolyte comprises lithium tetraborate; and based on the mass of the electrolyte, a mass percentage of the lithium tetraborate is Y %, wherein 0.3≤Y≤0.6; or
(3) the electrolyte comprises bis(neopentyl glycolato)diboron; and based on the mass of the electrolyte, a mass percentage of the bis(neopentyl glycolato)diboron is Z %, wherein 0.3≤Z≤0.6.

16. The electrochemical apparatus according to claim 9, wherein the electrolyte satisfies at least one of the following conditions:
(1) the electrolyte comprises dihydro-3-[3-(triethoxysilyl)propyl]furan-2,5-dione; and based on the mass of the electrolyte, a mass percentage of dihydro-3-[3-(triethoxysilyl)propyl]furan-2,5-dione is X %, wherein 1≤X≤2;
(2) the electrolyte comprises lithium tetraborate; and based on the mass of the electrolyte, a mass percentage of the lithium tetraborate is Y %, wherein 0.3≤Y≤0.6; or
(3) the electrolyte comprises bis(neopentyl glycolato)diboron; and based on the mass of the electrolyte, a mass percentage of the bis(neopentyl glycolato)diboron is Z %, wherein 0.3≤Z≤0.6.

17. The electrochemical apparatus according to claim 1, wherein the positive electrode active material layer comprises lithium cobalt oxide, carbon black, and polyvinylidene fluoride.

18. An electronic apparatus, comprising an electrochemical apparatus; the electrochemical apparatus comprises a positive electrode, a negative electrode, and an electrolyte; wherein the positive electrode comprises a positive electrode current collector and a positive electrode active material layer located on at least a part of a surface of the positive electrode current collector; a compacted density of the positive electrode active material layer is pd mg/cm³, wherein 2.60≤pd≤2.86; and
the electrolyte comprises ethylene carbonate, propylene carbonate, diethyl carbonate, ethyl propionate and propyl propionate; based on a mass of the electrolyte, a mass percentage of ethylene carbonate is A %, a mass percentage of propylene carbonate is B %, a mass percentage of diethyl carbonate is C %, a mass percentage of ethyl propionate is D %, and a mass percentage of propyl propionate is E %; wherein
$$1 ⩽ B / A ⩽ 8 , and 5 ⩽ ( E + D ) / C ⩽ 14.$$

19. The electronic apparatus according to claim 18, wherein the electrolyte satisfies at least one of the following conditions:
$$3 ⩽ A ⩽ 6 ; \qquad ( 1 )$$
$$12 ⩽ B ⩽ 20 ; \qquad ( 2 )$$
$$5 ⩽ C ⩽ 8 ; \qquad ( 3 )$$
$$20 ⩽ D ⩽ 30 ; \qquad ( 4 )$$
$$20 ⩽ E ⩽ 40 ; \qquad ( 5 )$$
$$2 ⩽ B / A ⩽ 6 ; or \qquad ( 6 )$$
$$8 ⩽ ( E + D ) / C ⩽ 10. \qquad ( 7 )$$

20. The electronic apparatus according to claim 18, wherein the electrolyte further comprises fluoroethylene carbonate; and based on the mass of the electrolyte, a mass percentage of the fluoroethylene carbonate is P %, wherein 5≤P≤20.
